(19) United States
(12) Patent Application Publication
(10) Pub. No.: US 2009/0184990 A1
(43) Pub. Date: Jul. 23, 2009

(54) METHODS AND APPARATUS FOR MEASURING DEPOSITED INK IN PIXEL WELLS ON A SUBSTRATE USING A LINE SCAN CAMERA

(75) Inventors: Quanyuan Shang, Saratoga, CA (US); John M. White, Hayward, CA (US)

Correspondence Address: DUGAN & DUGAN, PC, 245 Saw Mill River Road, Suite 309, Hawthorne, NY, 10532, US

(73) Assignee: APPLIED MATERIALS, INC., Santa Clara, CA (US)

(21) Appl. No.: 12/329,585

(22) Filed: Dec. 6, 2008

Related U.S. Application Data
(60) Provisional application No. 61/012,048, filed on Dec. 6, 2007.

(51) Int. Cl. B41J 29/38; B41J 29/393

(52) U.S. Cl. 347/6; 347/19

(57) ABSTRACT

Systems and methods for measuring deposited ink in a substrate are provided. The invention includes a light source adapted to transmit light through a deposited ink on a substrate, and a camera having a CCD sensor array wherein the camera is adapted to measure the amount of light that is transmitted through the deposited ink. Numerous other aspects are provided.

The present application claims priority from the following U.S. Provisional Patent Application, which is hereby incorporated by reference herein in its entirety:

U.S. Provisional Patent Application Ser. No. 61/012,048, filed Dec. 6, 2007, and entitled “METHODS AND APPARATUS FOR MEASURING DEPOSITED INK IN A SUBSTRATE USING A LINE SCAN CAMERA” (Attorney Docket No. 12812/L).

### CROSS-REFERENCE TO RELATED APPLICATIONS

This application is related to U.S. Provisional Patent Application Ser. No. 61/012,052, filed Dec. 6, 2007 and entitled “SYSTEMS AND METHODS FOR IMPROVING MEASUREMENT OF LIGHT TRANSMITTANCE THROUGH INK DEPOSITED ON A SUBSTRATE” (Attorney Docket No. 12767/L);

U.S. patent application Ser. No. ______, filed Dec. 6, 2008 and entitled “SYSTEMS AND METHODS FOR IMPROVING MEASUREMENT OF LIGHT TRANSMITTANCE THROUGH INK DEPOSITED ON A SUBSTRATE” (Attorney Docket No. 12767); and

U.S. patent application Ser. No. 11/758,631 filed Jun. 5, 2007 and entitled “SYSTEMS AND METHODS FOR CALIBRATING INKJET PRINT HEAD NOZZLES USING LIGHT TRANSMITTANCE MEASURED THROUGH DEPOSITED INK” (Attorney Docket No. 11129).

Each of these patent applications is hereby incorporated by reference herein in its entirety.

### FIELD OF THE INVENTION

The present invention relates generally to inkjet systems and more particularly to methods and apparatus for measuring deposited ink.

### BACKGROUND OF THE INVENTION

Flat Panel Displays (FPDs) often use substrates having ink wells with deposited ink. The deposited ink in the ink wells filter light that is transmitted through the ink well as part of an image display. For example, a red ink well may have deposited red ink that makes the white light transmitted through it red. Using an ink well with deposited ink (collectively referred to as a pixel) in combination with other pixels may form images on the display.

The images displayed may be undesirably affected by the amount of ink deposited in the substrate. For example, if a pixel has too much deposited ink, then the color of the light transmitting through the substrate (e.g., color filter) may have a shade of red that is deeper than desired. Conversely, if too little ink is deposited in the ink well then the color may appear less deep (e.g., pale, washed out, etc.). Accordingly, a portion of the display may display colors differently than other portions of the display. The properties of the transmitted light may be referred to as light color properties.

Inkjet systems are employed to deposit the ink in the ink well. Inkjet systems employ inkjet print heads that deposit ink in the ink wells as drops. The drops are typically volumetrically controlled. That is, the print heads include devices that control the volumes of ink that are in each drop of ink that is deposited in the ink wells. In some cases it may be difficult to accurately deposit a desired amount of ink in the ink wells. Accordingly, there is a need for accurately determining the amount of ink deposited in an ink well.

### SUMMARY OF THE INVENTION

In some aspects of the invention, an ink thickness measurement system includes a light source adapted to transmit light through deposited ink on a substrate, and a line scan camera having a charge-coupled device (hereinafter “CCD”) sensor wherein the camera is adapted to measure the amount of light that is transmitted through the deposited ink.

In some other aspects of the invention, an inkjet printing system includes a motion stage adapted to support a substrate; a print bridge adapted to support a plurality of print heads adapted to deposit ink on the substrate; a light source disposed one of above or below the motion stage and adapted to transmit light through the ink deposited on the substrate; and a camera supported by the print bridge and including a sensor array. The camera is adapted to measure the amount of light that is transmitted through the deposited ink. A subset of columns of the sensor array is each adapted to sequentially scan a selected line of the deposited ink.

In some other aspects of the invention, a method is provided that includes transmitting light through deposited ink on a substrate; receiving the transmitted light with a camera including a sensor array; selecting a set of columns of the sensor array; and measuring light transmittance through the deposited ink using a column of the selected set of columns of the sensor array that is over a selected line on the deposited ink.

Other features and aspects of the present invention will become more fully apparent from the following detailed description, the appended claims and the accompanying drawings.

### BRIEF DESCRIPTION OF THE DRAWINGS

FIG. 1 depicts a side cross section view of a first example embodiment of a deposited ink measurement system provided in accordance with the present invention.

FIG. 2 depicts an enlarged view of the deposited ink measurement system of FIG. 1, provided in accordance with embodiments of the present invention.

FIG. 3 depicts a first embodiment of a method of measuring deposited ink provided in accordance with the present invention.

FIGS. 4A and 4B depict a second example embodiment of a deposited ink measurement system provided in accordance with the present invention.

FIG. 5 depicts an enlarged view of the second example embodiment of the deposited ink measurement system of FIG. 3 provided in accordance with the present invention.

FIG. 6 depicts a second embodiment of a method of measuring deposited ink provided in accordance with the present invention.

### DETAILED DESCRIPTION

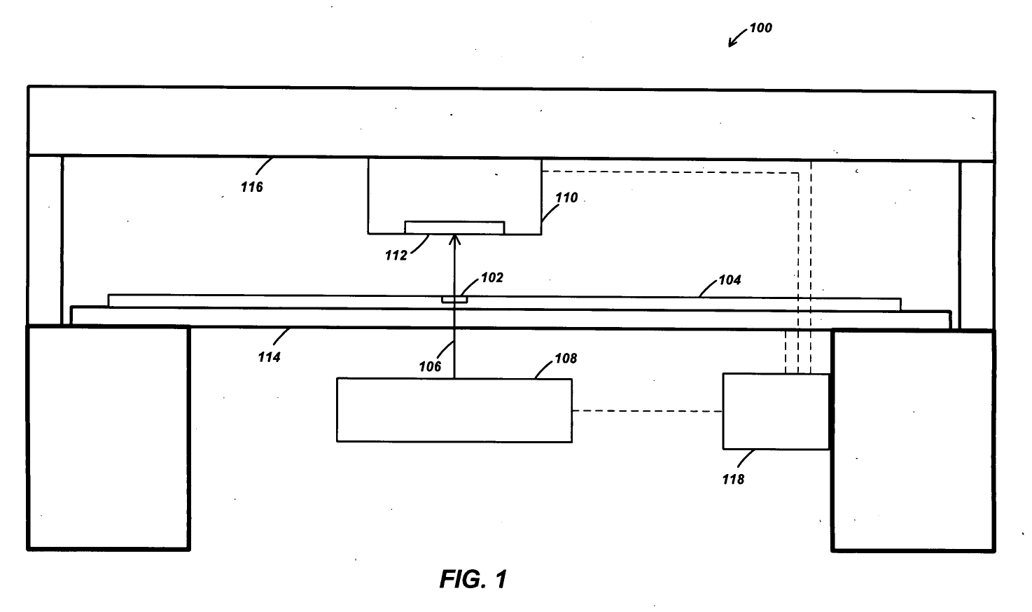

Methods and apparatus provided in accordance with the present invention accurately measure ink jetted or deposited onto a substrate into pixel wells. In some embodiments provided in accordance with the present invention, light transmitted through the deposited ink in an ink well (ink pixel) and received by a CCD camera array may be measured, and this measurement, which may be directly related to the thickness of the deposited ink, may be used to determine the thickness of the deposited ink and the amount of ink deposited in the pixel well. In the same, or in alternative, embodiments, a subset of CCD sensors in the CCD camera array (e.g., a relatively narrow column of sensors centrally located in the CCD array) may be selected such that the transmitted light may be measured using only the reduced number of selected CCD sensors. Accordingly, the deposited ink may be measured with camera pixels that experience less light variation (e.g., more consistent light intensity), thereby improving the accuracy of the measurement. In some embodiments, light transmitted through the same ink well may be measured repeatedly by different columns of CCD sensors and the measurements may be integrated together to more accurately measure the light transmittance through the ink well. This time delay integration type measurement may be performed by moving the camera (and light source) or substrate (supported on a moveable stage) while measuring the light transmittance through a single spot in the ink well with different columns of CCD sensors and cumulatively shifting the measurement results to the next column used to subsequently measure the light transmittance. These and other aspects of the invention are described below with reference to FIGS. 1-6.

FIG. 1 depicts a side cross section view of a first example embodiment of a deposited ink measurement system 100 provided in accordance with the present invention. The measurement system 100 measures deposited ink 102 on a substrate 104 with transmitted light 106. The transmitted light 106 may be transmitted from a light source 108 to a camera 110 through the deposited ink 102 and the substrate 104. The camera 110 may have a CCD array 112 that receives the transmitted light 106. The camera 110 may convert the transmitted light 106 to signals (e.g., digital) that may be used to calculate the thickness of the deposited ink 102 as will be described in more detail below.

In some embodiments, the substrate 104 may be supported on a stage 114 of an inkjet printing system. The stage 114 may include a window to allow light 106 from the light source 108 (e.g., disposed and supported below the stage 114) to reach the substrate 104 and the camera 110 which may be disposed above the stage 114. The camera 110 may be supported on a print bridge 116 of the inkjet printing system. In some embodiments, both the light source 108 and camera 110 may be disposed together above (or below) the stage 114 and a reflective surface may be employed to direct the light back through the substrate to the camera. By including the deposited ink measurement system 100 in an inkjet printing system, the ink may be deposited on the substrate 104, and then, without having to remove the substrate 104 from the inkjet printing system, an in situ measurement of the amount of ink deposited may be made. This saves time and allows more accurate measurement of the deposited ink which may include evaporating solvents and thus, have a changing volume.

The deposited ink 102 in the pixel matrix of the substrate 104 may be any suitable ink that is capable of being measured by the transmitted light 106. The transmitted light 106 may be a white light (e.g., spectrum that appears as a white light to a person) although any suitable spectrum range may be employed. For example, it may be desirable to employ a particular frequency band that is more accurate with a particular CCD array or more suitable for a particular ink formulation or ink color. The transmitted light 106 may also be any suitable brightness. For example, it may be desirable that the transmitted light 106 is a white light that is about 10 to 1,000,000 cd bright although the light may be more or less bright. The transmitted light 106 may be provided by the light source 108.

The light source 108 may be a light emitting diode although any suitable light source may be employed. The light source 108 may be directional (e.g., laser, focused, collimated, etc.) although a non-directional (e.g., radiant) light source may be employed. The light source 108 may be homogenized, unified, diffused and/or integrated.

The camera 110 having the CCD array 112 may be a single or multiple pixel CCD camera though any suitable camera 110 and/or CCD array 112 may be employed. The camera 110 may include electronics that read data from the CCD array 112. For example, the camera 110 may have a data reader circuit that is adapted to select the rows and columns of the CCD array 112 to read data from a particular CCD sensor. The camera 110 may also include circuits and/or algorithms that filter, integrate, and/or prepare the data read from the CCD array 112 for interpretation. The camera 110 may also include a circuit that is adapted to communicate with other devices and/or computers. For example, the camera 110 may include a Universal Serial Bus (USB) circuit that converts the read data to the USB communication protocol. Thus, another device and/or computer may read the data from the camera 110 for comparison with the other data and/or selected values.

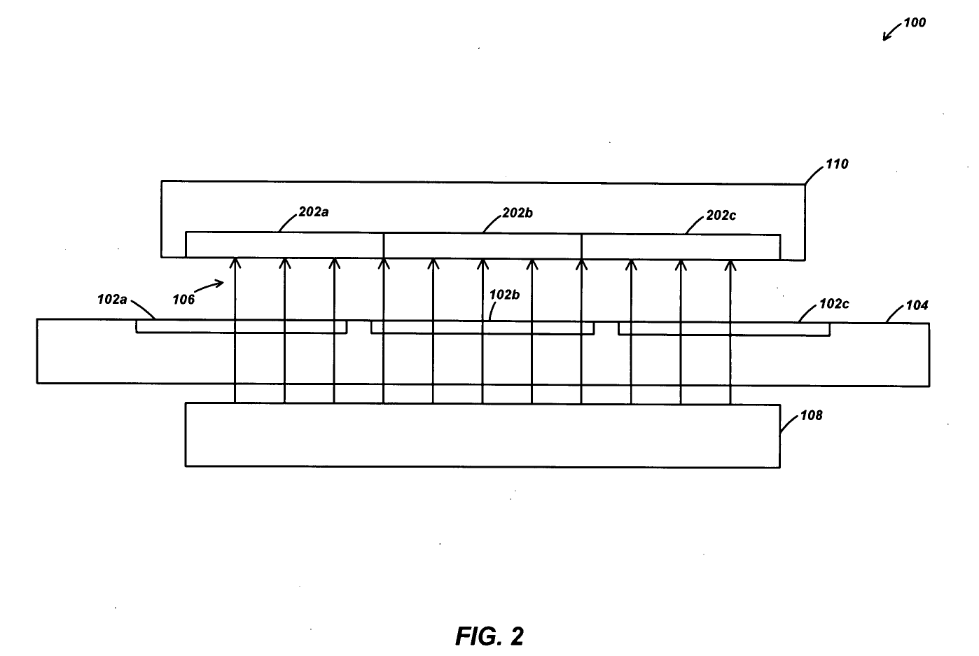

In operation, the transmitted light 106 is transmitted through the deposited ink 102 from the light source 108 to the CCD array 112. The CCD array 112 receives the transmitted light 106 and converts the transmitted light 106 into a signal. For example, the CCD array 112 may convert the received transmitted light 106 into a binary representation of spectrum, intensity, brightness, power, level, amplitude, or any other suitable transmitted light parameter. Such signal may be stored and/or transmitted. For example, the signal may be stored in a memory circuit that is interstitial or interwoven with the CCD sensors. The memory circuit may have word lines (WL) and read lines (RL) that reference a particular CCD pixel. Accordingly, the camera 110 or any other suitable device may read the signal provided by the CCD array 112 at any particular CCD sensor. Groups of such CCD sensors may be selected to measure the deposited ink 102 as will be described in more detail in the subsequent description of FIGS. 2-6.

In some embodiments, the inkjet printing system may further include a controller 118, wherein the controller 118 may be adapted to control movement of the stage 114 supporting the substrate 104 as well as movement and operation (e.g., sequencing of exposures) of the camera 110 and light source 108.

In some embodiments the light sources may include optical components adapted to help improve the consistency of the intensity and color of the light beam emitted by the light source and used to measure transmittance. Improved consistency allows more accurate measurement results. In some embodiments of the present invention, the optical component may include one or more color filters, which may correspond to the colors of the deposited ink to be measured. For example, a selected filter may be used to restrict the light from the light source to a desired range of wavelengths, thereby providing a light beam that may be more uniform in intensity and color. In some embodiments, a filter switching mechanism may be used to select different color filters. A different color filter may be selected based on a desired wavelength to be restricted and/or transmitted. In some embodiments, during a calibration procedure, the system may make a reference measurement for each of the filtered light colors and for a white light reference. The appropriate data may then be correlated with the corresponding measurement of the corresponding colored ink. In this manner, the amount of light transmitted through the pixel wells may be determined relative to the reference measurement.

FIG. 2 depicts an enlarged side cross-sectional view of the deposited ink measurement system 100 provided in accordance with the present invention. The enlarged view of the deposited ink measurement system 100 depicts the first substrate 104 including three pixel wells each containing deposited ink 102a-c. Transmitted light 106 is depicted as a plurality of arrows that represent a light beam. Also as depicted, the CCD array 112 is divided into CCD sensor sub-arrays 202a-c.

Each of the CCD sensor sub-arrays 202a-c may include a plurality of selected CCD sensors. The CCD array 112 may be represented as arrays of m by n CCD sensors where m is the ‘row’ and n is the ‘column’ of the CCD array 112. Each of the CCD sensor sub-arrays 202a-c may be a subset or smaller range of m by n CCD sensors. For example, in a 2048×192 array of CCD sensors, the center 2048×96 sensors may be the center CCD sensor sub-array 202b. That is, the center 2048×96 CCD sensors are employed to sense the transmitted light 106. The first and third CCD sensor sub-arrays 202a and 202c may be configured to not detect the transmitted light 106. Additionally or alternatively, the first and third CCD sensor sub-arrays 202a and 202c may detect the transmitted light but the corresponding data may not be read, communicated and/or analyzed. In some cameras, the center CCD sensor sub-array 202b may receive a more homogenous sample of light and not experience boundary or edge effects due to, for example, blocked or redirected light from the aperture or the lens.

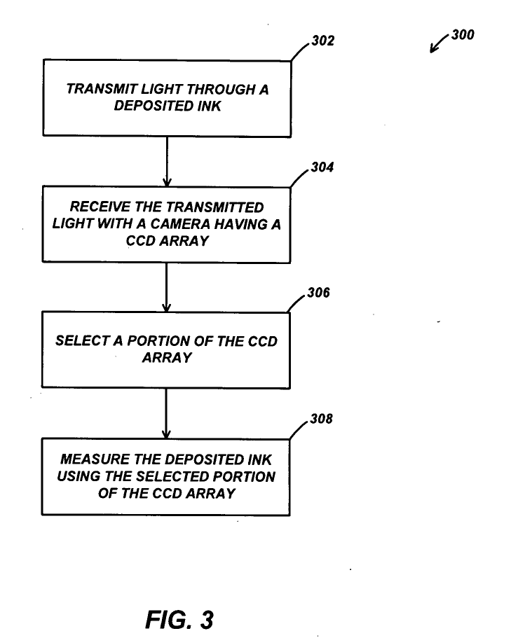

FIG. 3 depicts a first example embodiment of a method 300 of measuring deposited ink provided in accordance with the present invention. The method 300 of measuring deposited ink measures deposited ink by employing the CCD array 112 described above. In step 302, according to the method 300, light is transmitted through deposited ink on a substrate. Subsequently, the transmitted light is received by the camera 110 having the CCD array 112 in step 304. In step 306, the first method 300 selects a CCD sub-array 202a-c. The selected CCD sub-array 202a-c is used to measure the deposited ink in step 308.

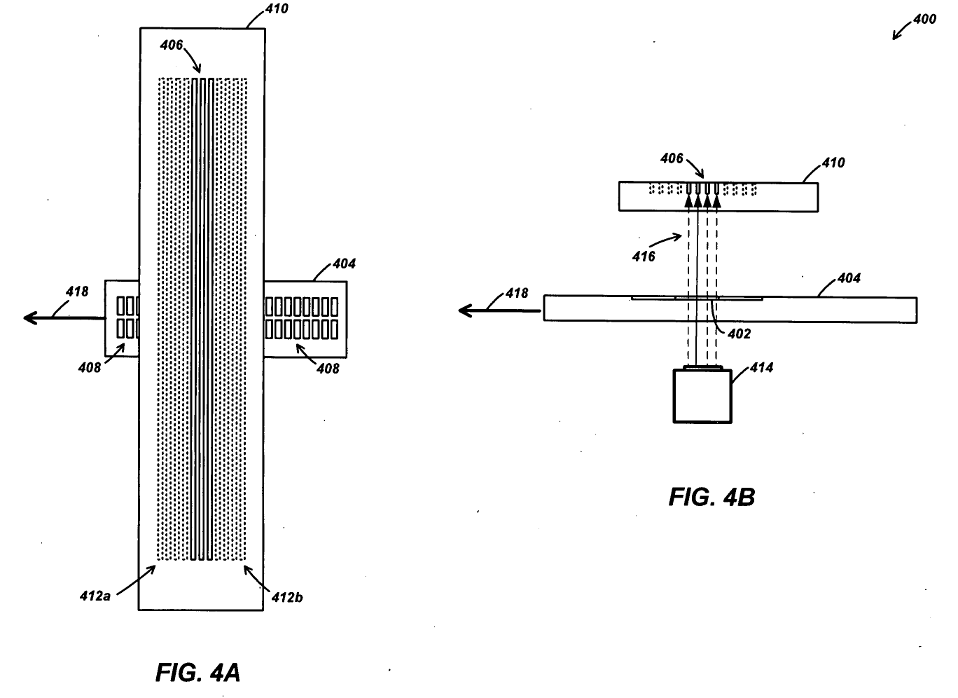

FIGS. 4A and 4B schematically depict a second example embodiment of a deposited ink measurement system 400 provided in accordance with embodiments of the present invention. This second example embodiment of the deposited ink measurement system 400 may inspect deposited ink 402 on a substrate 404 using selected CCD array columns 406 while scanning the substrate 404. The deposited ink 402 may be included among other deposited ink 408 that may also be on the substrate 404. As depicted, the selected CCD array columns 406 may be included in a camera 410, e.g., a line scan camera. The camera 410 may also include unselected CCD array columns 412a, 412b (shown in phantom). The selected CCD array columns 406 may receive transmitted light from a light source 414 along a plurality of light paths 416. Data obtained from the plurality of light paths 416 may be combined (e.g., by time delay integration (TDI)) to measure, e.g., light transmittance through the deposited ink 402. In some embodiments, a controller, such as the controller 118 shown in FIG. 1, may be adapted to use time delay integration to determine the thickness of the deposited ink based on measured light transmittance. Additionally or alternatively, the substrate 404 may move past the camera 410 and light source 414 as depicted by the substrate direction arrows 418.

The deposited ink 402 is disposed on the substrate 404. The deposited ink 402 and the substrate 404 may be the same as or similar to the deposited ink 102 and substrate 104, respectively, described above.

The selected CCD array columns 406 may include any suitable number of columns of CCD sensors. For example, the CCD selected CCD array columns 406 may be comprised of the middle 2048×96 CCD sensors in a in a 2048×192 array of CCD sensors.

The plurality of ink wells with deposited ink 408 may be any suitable number and configuration of ink wells with deposited ink 402. Although the plurality of deposited ink 408 is depicted as being arranged as only two rows of ink wells, more or fewer number of rows of ink wells with deposited ink 402 may be measured. Additionally or alternatively, the ink pixel matrix may be staggered (e.g., not rectangular in shape). A deposited ink measurement system 400 provided in accordance with the present invention may be used with any suitable configuration of deposited ink 402.

The camera 410 may be any suitable camera. For example, the second camera 410 may be the HS-80-08k40 manufactured by Dalsa, Inc. The camera 410 may be able to measure a feature on a ‘work piece’ (e.g., the deposited ink 402 on the substrate 404) using each column in the selected CCD array columns 406. Additionally or alternatively, the camera 410 may be adapted to perform calculations on the data that is provided by the selected CCD array columns 406. For example, the data from each column of the selected CCD array columns 406 may be captured at different times and be cumulatively added together. Accordingly, the sensitivity of the camera 410 may be improved in low light conditions.

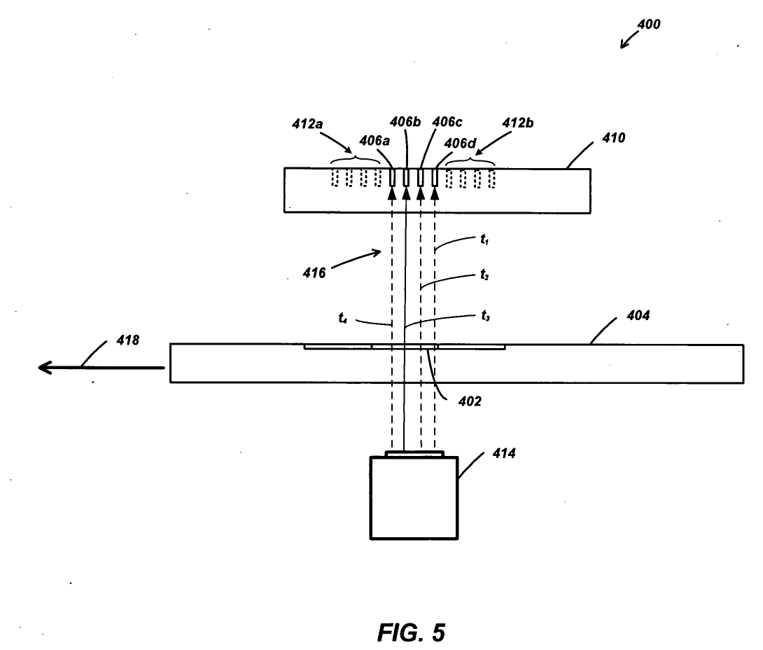

The plurality of light paths 416 may be directional light that is transmitted through the deposited ink 402. As will be explained in more detail below with respect to FIG. 5, the individual columns of the selected CCD array columns 406 may capture an exposure or measurement of light transmitted through the same spot (or line into the page) of the deposited ink 402 at different times to facilitate time delay integration.

FIG. 5 depicts an enlarged view of the second example embodiment of a deposited ink measurement system 400 provided in accordance with the present invention. As indicated above, this embodiment of a deposited ink measurement system 400 is adapted to scan the deposited ink 402 on the substrate 404 using the selected CCD array columns 406a-d. The deposited ink measurement system 400 may be adapted to employ time delay integration (TDI), via the controller 118, for example, also mentioned above. By employing TDI, the deposited ink 402 may be measured along a narrow line as it is moved past the array columns 406a-d (only four are depicted for illustrative purposes but many more may be used, e.g., 96) of the selected CCD array columns 406.

For example, as the substrate 404 is moved in the direction indicated by arrow 418 relative to the camera 410 and the light source 414, at time t₁, CCD array column 406d may capture an exposure of light transmitted through the center of the deposited ink 402. At time t₂, CCD array column 406c may capture an exposure of light transmitted through the center of the deposited ink 402. At time t₃, CCD array column 406b may capture an exposure of light transmitted through the center of the deposited ink 402. Note that in FIG. 5, as indicated by the solid arrow (as opposed to the phantom arrows) extending from the light source 414 through the center of the deposited ink 402 to the CCD array column 406b, the substrate 404 is depicted at the position corresponding to time t₃. In other words, the light being measured in FIG. 5 is passing through the center of the deposited ink. At time t₄, CCD array column 406a may capture an exposure of light transmitted through the center of the deposited ink 402.

The measurements of the deposited ink 402 taken at the different times are cumulatively integrated such that a stronger signal is obtained from the transmitted light along each of light paths 416. Additionally or alternatively, TDI may use the accumulation of multiple exposures of the same (moving) object, in this case the center of the deposited ink 402 (e.g., a line through the center of the deposited ink 402), effectively increasing the integration time available to collect the transmitted light. The movement of the deposited ink 402 illustrated by the substrate direction arrows 416 may be coordinated or synchronized with the sequence of exposures of each column of the selected CCD array columns 406a-d. As described above, in some embodiments, the controller 118 may be employed to coordinate the movement of the substrate 404 and the capturing of exposures by the camera 410. In some embodiments, the controller 118 may be part of an inkjet printing system adapted to control movement of a stage supporting the substrate as well as movement and operation (e.g., sequencing of exposures) of the camera 410 and light source 414.

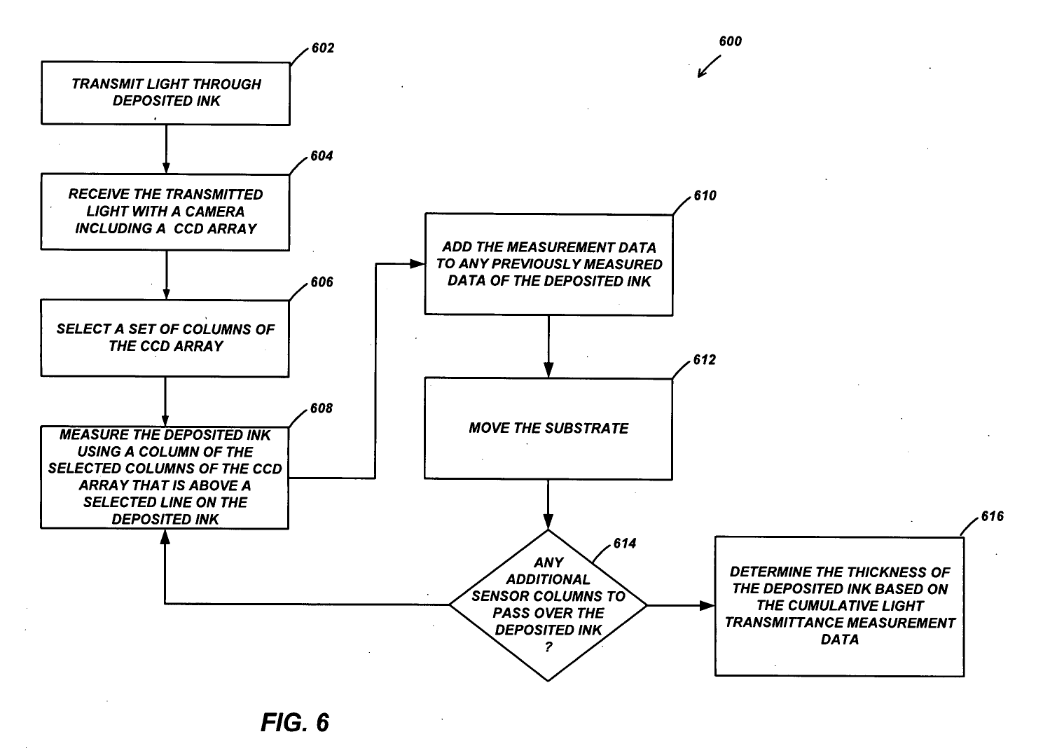

FIG. 6 depicts a second exemplary deposited ink measurement method 600 provided in accordance with the present invention. The second exemplary deposited ink measurement method 600 measures deposited ink using a selected set of columns from a CCD array. In step 602, light is transmitted through the deposited ink 402. Subsequently, in step 604, the transmitted light is received by the camera 410 that includes a CCD array. In step 606, a set of CCD array sensors are selected. For example, in some embodiments, an inner set of CCD array sensors may be selected. In step 608, an exposure is measured by a column of CCD array sensors disposed above a selected line on the deposited ink. The measured light transmittance data is added to any previously measured light transmittance data in Step 610. In step 612 the substrate 404 is moved. In step 614, a determination is made whether there are any additional columns of CCD array sensors in the selected inner set to pass over the selected line on the deposited ink. If yes, the method 600 loops back to step 608. If no, the cumulative light transmittance measurement data is used to determine the thickness of the deposited ink in step 616.

The foregoing description discloses only exemplary embodiments of the invention. Modifications of the above disclosed apparatus and methods which fall within the scope of the invention will be readily apparent to those of ordinary skill in the art. For instance, in some embodiments, the camera may be combined with other cameras to measure the deposited ink. Further, the present invention may also be applied to spacer formation, polarizer coating, and nanoparticle circuit forming.

Accordingly, while the present invention has been disclosed in connection with exemplary embodiments thereof, it should be understood that other embodiments may fall within the spirit and scope of the invention, as defined by the following claims.

The invention claimed is:

1. A system comprising:
a light source adapted to transmit light through ink deposited on a substrate; and
a camera having a sensor array wherein the camera is adapted to measure the amount of light that is transmitted through the deposited ink,
wherein a subset of columns of the sensor array is adapted to sequentially scan a selected line of the deposited ink.

2. The system of claim 1 further comprising a controller adapted to use time delay integration to determine the thickness of the deposited ink based on the measured light transmittance.

3. The system of claim 2 wherein time delay integration uses an accumulation of multiple scans of the selected line of the deposited ink.

4. The system of claim 1 wherein the camera is adapted to convert the transmitted light to signals used to determine the thickness of the deposited ink.

5. The system of claim 1 wherein the sensor array is a charge-coupled device array.

6. The system of claim 1 wherein the camera is adapted to cumulatively add data from the subset of columns.

7. An inkjet printing system comprising:
a motion stage adapted to support a substrate;
a print bridge adapted to support a plurality of print heads adapted to deposit ink on the substrate;
a light source disposed one of above or below the motion stage and adapted to transmit light through the ink deposited on the substrate; and
a camera supported by the print bridge and including a sensor array wherein the camera is adapted to measure the amount of light that is transmitted through the deposited ink,
wherein a subset of columns of the sensor array is adapted to sequentially scan a selected line of the deposited ink.

8. The inkjet printing system of claim 7 further comprising a controller adapted to use time delay integration to determine the thickness of the deposited ink based on measured light transmittance.

9. The inkjet printing system of claim 7 wherein the motion stage is adapted to move the substrate.

10. The inkjet printing system of claim 9 wherein the movement of the substrate is coordinated with the sequence of scans of the selected line of the deposited ink.

11. The inkjet printing system of claim 8 wherein time delay integration uses an accumulation of multiple scans of the selected line of the deposited ink.

12. The inkjet printing system of claim 8 wherein the determination of the thickness of the deposited ink is an in situ measurement.

13. The inkjet printing system of claim 7 wherein the camera is disposed together with the light source one of above or below the motion stage.

14. The inkjet printing system of claim 13 further comprising a reflective surface adapted to direct the light back through the substrate to the camera.

15. A method comprising:
transmitting light through deposited ink on a substrate;
receiving the transmitted light with a camera including a sensor array;
selecting a set of columns of the sensor array; and
measuring light transmittance through the deposited ink using a column of the selected set of columns of the sensor array that is over a selected line on the deposited ink.

16. The method of claim 15 further comprising:
storing the received signal.

17. The method of claim 15 further comprising:
moving the substrate on a motion stage of an inkjet printing system.

18. The method of claim 17 further comprising:
repeating the measuring with each column of the selected set of columns of the sensor array.

19. The method of claim 18 further comprising:
integrating the light transmittance measurements together.

20. The method of claim 19 further comprising
determining a thickness of the deposited ink based on the integration of the light transmittance measurements.

21. The method of claim 15 wherein the received transmitted light is received along a plurality of light paths.

22. The method of claim 21 further comprising:
combining data obtained from the plurality of light paths.

23. The method of claim 22 wherein time delay integration is used to combine the data.

24. The method of claim 21 wherein the plurality of light paths is directional light.
